(19) United States
(12) Patent Application Publication
(10) Pub. No.: US 2012/0117732 A1
(43) Pub. Date: May 17, 2012

(54) FOLD DOWN FOOTBOARD

(76) Inventor: Christopher R. O'Keefe, Batesville, IN (US)

(21) Appl. No.: 12/947,069

(22) Filed: Nov. 16, 2010

(51) Int. Cl. A61G 7/015; A61G 7/05

(52) U.S. Cl. 5/613; 5/624

(57) ABSTRACT

A patient support apparatus is convertible between a horizontal bed position, having a generally horizontal sleeping surface upon which a person lies in a supine position, and a chair egress position, allowing a person to exit the patient support apparatus from a sitting position. The patient support apparatus includes a deck and a footboard coupled to the deck. The footboard may be stowed while the patient support apparatus is in the chair egress position without being removed from the patient support apparatus.

### BACKGROUND

The present disclosure relates to a patient support apparatus, such as a hospital bed, for supporting a patient. More particularly, the present disclosure relates to a footboard.

Hospital beds known in the art are configured to move between a horizontal bed position, wherein a patient support surface is generally flat, and a chair egress position, wherein the foot end portion of the patient support surface is lowered so that a patient can egress or exit the bed from a sitting position. A footboard is often attached to the foot end of the patient support surface to provide a barrier.

In the prior art, when the foot end of the patient support surface is lowered, the footboard is removed to allow a patient to egress or exit.

### SUMMARY

The present application discloses one or more of the features recited in the appended claims and/or the following features which, alone or in any combination, may comprise patentable subject matter.

According to one aspect of the present disclosure patient support apparatus includes a deck having a head end and a foot end, a mattress assembly supported on the deck, and a footboard coupled to the deck. The footboard is movable between a barrier position and a stowed position. In the barrier position, the footboard extends above a top surface of the mattress assembly. In the stowed position, the footboard is below the top surface of the mattress assembly.

In some embodiments, the footboard may be pivotable about an approximately horizontal axis along the foot end of the deck over more than 180 degrees relative to the deck. The footboard may be pivotable over about 270 degrees relative to the deck.

The footboard may maintain a selected position relative to the deck at any angle within the footboard range of motion relative to the deck. The footboard may be pivotable between the barrier position, the stowed position, and a shelf position wherein the footboard extends generally parallel to a floor.

The deck may be movable between a horizontal bed position, having a generally horizontal sleeping surface upon which a person lies in a supine position, and a chair egress position, allowing a person to exit the foot end of the bed from a sitting position. The deck may be movable to the chair egress position when the footboard is moved to the stowed position. The footboard may be movable to the barrier position when the deck moves away from the chair egress position.

According to another aspect of the invention, a patient support apparatus includes a deck having a head end and a foot end, and a footboard coupled to the foot end of the deck. The footboard is expandable and retractable within a footboard footprint to increase and reduce the overall height of the footboard. The footboard footprint is defined by the length dimension of the footboard extending from the foot end of the deck to the foot end of the footboard and the width dimension of the footboard extending along at least a portion of the foot end of the deck.

In some embodiments, the footboard may include a series of chambers expandable and retractable between a first position and a second position. In the first position the top surface of each chamber may be spaced apart from the top surface of each other chamber. In the second position, the top surface of at least one chamber may be adjacent to the top surface of another chamber.

The deck may be movable between a horizontal bed position having a generally horizontal sleeping surface upon which a person lies in a supine position and a chair egress position allowing a person to exit the patient support apparatus from a sitting position. The footboard may be retracted to the second position when the deck is moved to the chair egress position.

In some embodiments, the footboard may include a plurality of inflatable bladders. The plurality of inflatable bladders may extend approximately horizontally along the foot end of the deck.

In other embodiments, the footboard may include a plurality of telescoping members. Each of the plurality of telescoping members may overlap a portion of another telescoping member creating a friction fit when the footboard is in the first position.

In some embodiments, the patient support apparatus may further comprise a mattress assembly supported on the deck. The footboard may be movable between a barrier position and a stowed position. In the barrier position the footboard may extend above a top surface of the mattress assembly. In the stowed position the footboard may be below the top surface of the mattress assembly.

In some embodiments the deck may be movable between a horizontal bed position having a generally horizontal sleeping surface upon which a person lies in a supine position and a chair egress position allowing a person to exit the support from a sitting position. The footboard may be moved to the stowed position when the deck is in the chair egress position. Additionally, the footboard may expand and retract between, and may be maintained at a plurality of heights.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived

### BRIEF DESCRIPTION OF THE DRAWINGS

The detailed description particularly refers to the accompanying figures, in which:

FIG. 1 is a perspective view of a patient support apparatus having a head end and a foot end including a footboard configured to pivot about the foot end of the patient support apparatus;

FIG. 2 is a side view of the patient support of FIG. 1 wherein the footboard is in a barrier position;

FIG. 3 is a side view of the patient support of FIG. 1 wherein the footboard is in a shelf position;

FIG. 4 is a side view of the patient support of FIG. 1 wherein the footboard is in a stowed position and the patient support apparatus is in a chair egress position;

FIG. 5 is a diagrammatic view of the patient support of FIG. 1 including a controller, a mover, and a user interface;

FIG. 6 is a perspective view of a patient support apparatus with another footboard embodiment in a barrier position and including a plurality of inflatable members;

FIG. 7 is a perspective component view of the footboard of FIG. 6 in the barrier position;

FIG. 8 is a perspective component view of the footboard of FIG. 6 in a stowed position;

FIG. 9 is a diagrammatic view of the patient support apparatus and footboard of FIG. 6 showing a controller, a mover, and a user interface;

FIG. 10 is a perspective view of another footboard embodiment in a barrier position and including a plurality of telescoping members;

FIG. 11 is a perspective view of the footboard of FIG. 10 in a stowed position;

FIG. 12 is an end view of another footboard embodiment in a barrier position and including a first plurality of telescoping members and a second plurality of telescoping members;

FIG. 13 is an end view of the footboard of FIG. 12 in a stowed position;

FIG. 14 is a perspective component view of a single telescoping member of the plurality of telescoping members of FIG. 12;

FIG. 15A is a first side component view of the single telescoping member of FIG. 14; and

FIG. 15B is a second side component view of the single telescoping member of FIG. 14.

### DETAILED DESCRIPTION OF THE DRAWINGS

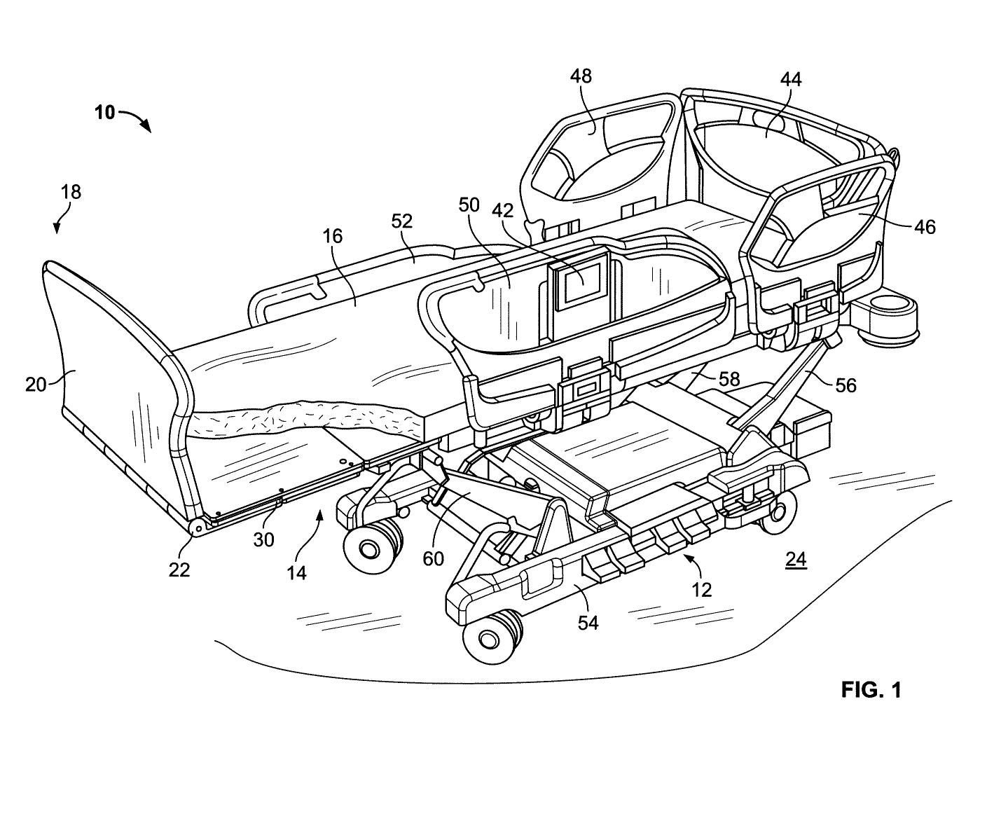

A patient support apparatus is illustratively embodied as a hospital bed 10 having a base 12, a deck 14, and a mattress assembly 16 as shown in FIG. 1. The deck 14 is supported by the base 12. The deck 14 supports the mattress assembly 16. The bed 10 is movable between a horizontal bed position, wherein the deck 14 is generally flat, and a chair egress position, wherein the deck 14 is moved from the horizontal bed position so that the bed 10 is configured to allow a patient to egress or exit the bed 10 from a sitting position.

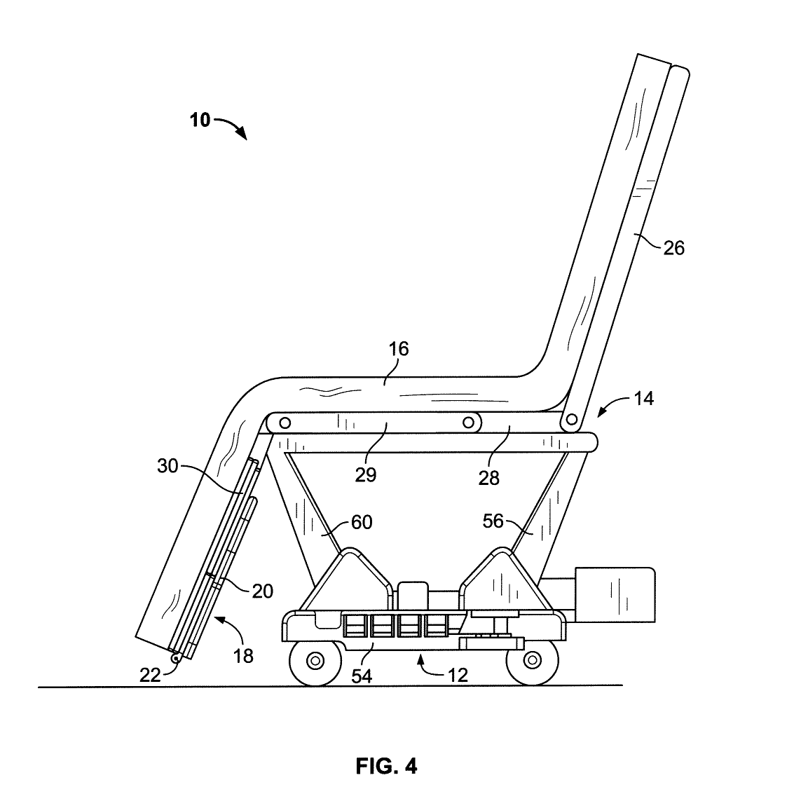

The bed 10 includes a footboard 18. The footboard 18 includes a footboard body 20 and a footboard pivot member 22. The footboard body 20 extends from the footboard pivot member 22. The footboard 18 is movable between a barrier position as shown in FIG. 1, where the footboard extends generally perpendicularly from the deck 14 above the top surface of the mattress assembly 16, and a stowed position, where the footboard 18 is pivoted to be stored under the deck 14 as shown in FIG. 4. The footboard 18 is positionable at any angle relative to the deck 14 between the barrier position and the stowed position. For example, the footboard 18 is movable to a shelf position, wherein the footboard 18 is positioned to extend parallel with the floor 24.

The deck 14 comprises a head deck section 26, a seat deck section 28, a thigh deck section 29, and a foot deck section 30. The head deck section 26 is pivotably coupled to the seat deck section 28. The seat deck section 28 is pivotably coupled to the thigh deck section 29. The thigh deck section 29 is pivotably coupled to the foot deck section 30.

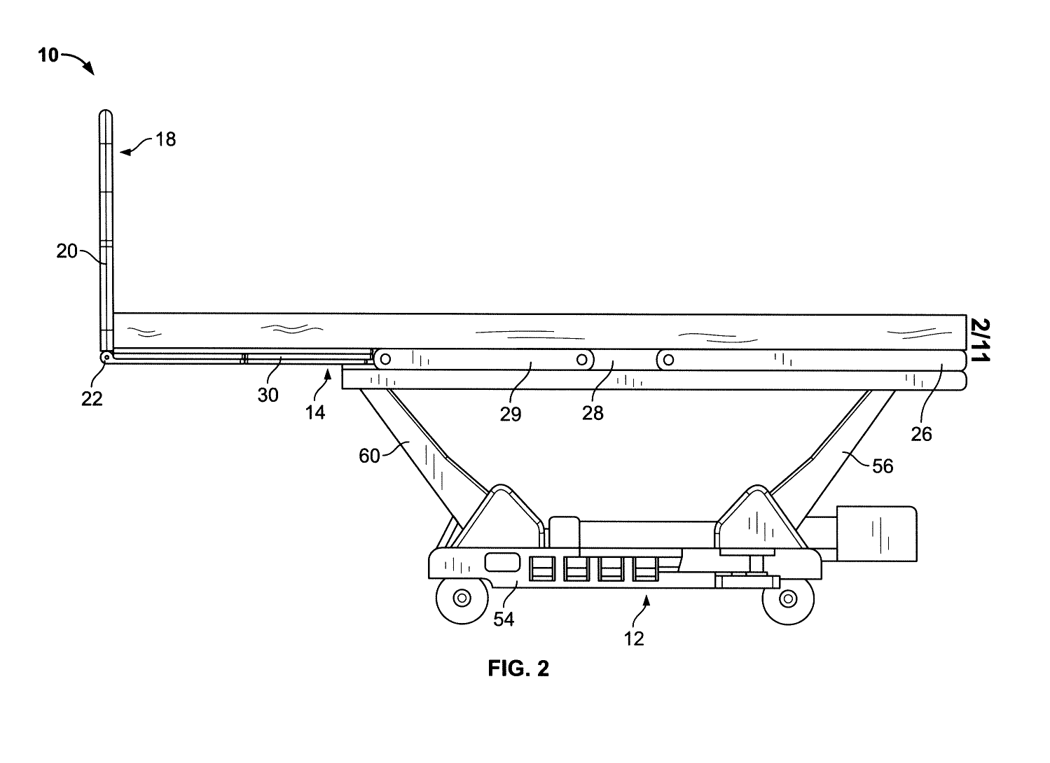

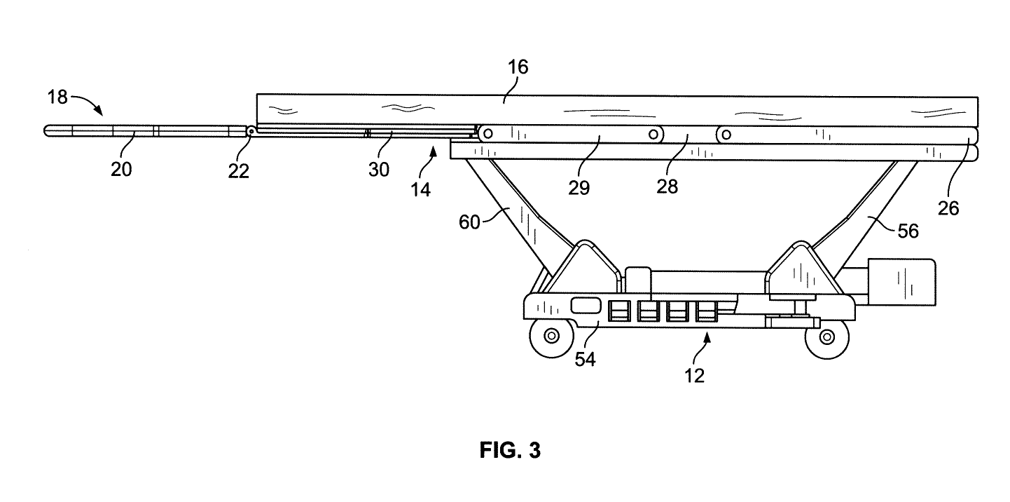

The footboard 18 further includes a footboard mover 32 and a footboard position sensor 34. The footboard pivot member 22 is coupled to the foot end of the foot deck section 30. The footboard mover 32 is configured to move the footboard 18 between the barrier position and the stowed position. In the embodiment shown in FIGS. 1-4, the footboard mover 32 is a stepper motor. In other embodiments, the footboard mover 32 is a linear actuator and linkage. The footboard position sensor 34 provides a signal indicative of the angle formed by the footboard 18 relative to the foot deck section 30. In the illustrative embodiment, the footboard position sensor 34 is a potentiometer.

The deck 14 includes a head deck position sensor 36 and a foot deck position sensor 38. The head deck position sensor 36 provides a signal indicative of the angle formed by the head deck section 26 relative to the seat deck section 28. The foot deck position sensor 38 provides a signal indicative of the angle formed by the foot deck section 30 relative to the thigh deck section 29. In the illustrative embodiment, the head deck position sensor 36 and the foot deck position sensor 38 are potentiometers.

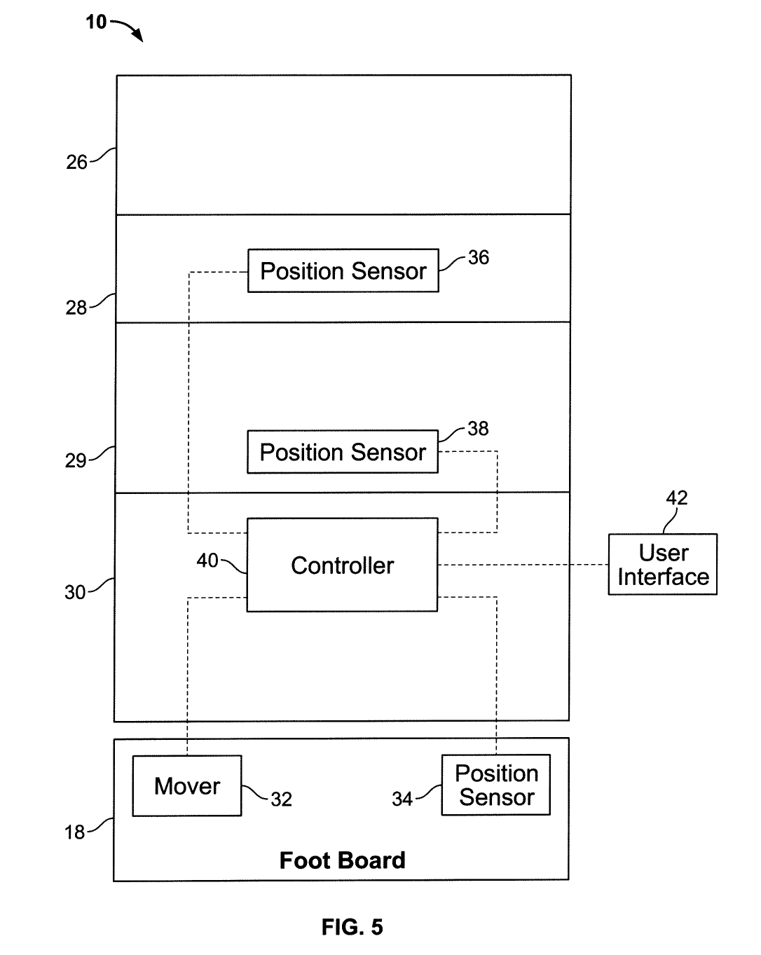

The bed 10 further includes a controller 40 and a user interface 42 shown in FIG. 5. The controller 40 is in communication with the footboard mover 32 and is controls movement of the footboard mover 32 to drive the footboard 18 between the barrier position and the stowed position. The controller 40 controls movement the deck 14 to move between the horizontal bed position and the chair egress position. The controller 40 is in communication with the user interface 42, the footboard position sensor 34, the head deck position sensor 36, and the foot deck position sensor 38. The user interface 42 receives inputs from a caregiver requesting movement of the deck 14 between the horizontal bed position and the chair egress position. The user interface 42 is an LCD touch screen and is operable to display an icon corresponding to the horizontal bed position and an icon corresponding to the chair egress position.

A caregiver requests movement of the deck 14 from the horizontal bed position to the chair egress position by selecting the chair egress icon on the user interface 42. When the caregiver has selected the chair egress position, the controller 40 signals the footboard mover 32 to drive the footboard 18 to the stowed position before moving the deck 14 from the horizontal bed position. Thus, the footboard 18 is in the stowed position before the deck 14 moves from the horizontal bed position and will not contact the floor 24. In other embodiments, the controller 40 may move the footboard 18 simultaneously with the deck 14 from the horizontal bed position to the chair egress position.

A caregiver requests movement of the deck 14 from the chair egress position to the horizontal bed position by selecting the horizontal bed icon on the user interface 42. When the caregiver selects the horizontal bed position icon, the controller 40 signals the deck 14 to begin movement from the chair egress position to the horizontal bed position. The controller 40 also communicates with the head deck position sensor 36 and the foot deck position sensor 38 to determine if the head deck position sensor 36 and the foot deck position sensor 38 indicate that the head deck section and the foot deck sections have reached a set of preprogrammed angles corresponding with a sufficient clearance state. When the deck 14 is in the sufficient clearance state, enough clearance is available between the foot end of the deck 14 and the floor 24 for the footboard 18 to be moved to the requested position without contacting the floor 24. When the controller 40 has signaled the deck 14 to begin movement from the chair egress position to the horizontal bed position and the controller 40 determines that the deck 14 is in the sufficient clearance state, the controller 40 signals the footboard mover 32 to drive the footboard 18 from the stowed position to the barrier position. The footboard 18 will not move from the stowed position toward the floor 24 until the controller 40 has determined that enough clearance exists between the deck and the floor to avoid footboard 18 contact with the floor 24.

Additionally, the user interface 42 receives inputs from a caregiver requesting increases and decreases in the angle of the footboard 18 relative to the deck 14 between the angles formed in the barrier position and the stowed position. When a caregiver requests an angle increase or decrease, the controller 40 will signal the footboard mover 32 to drive the footboard 18 in the requested direction if the deck 14 is in the sufficient clearance state. Thus, the footboard 18 is positionable at any angle along about 270 degrees of rotation relative to the foot deck section 30.

In other embodiments, the footboard 18 does not include a footboard mover 32. In such embodiments, the footboard 18 is manually movable to any angular position relative to the foot deck section 30, between and including, the barrier and stowed positions. Further in such embodiments, the footboard 18 may be held at any available angular position by a clamp, a latch, or any other suitable mechanism for holding the footboard in position relative to the foot deck section 30.

The bed 10 further includes a headboard 44, a first head rail 46, and a second head rail 48. The headboard extends along the head end of the deck 14. The headboard 44 also extends above the mattress assembly 16 when the deck 14 is in the horizontal bed position and the mattress assembly 16 is present. The first and the second head rails 46, 48, extend along at least a portion of the head deck section 26 and above the mattress assembly 16 when the mattress assembly 16 is present. The headboard 44 is removable from the bed 10.

The bed 10 also comprises a first side rail 50 and a second side rail 52. The first and the second side rails 50, 52, extend along the deck 14 and above the mattress assembly 16, when the mattress assembly 16 is present. The first and the second head rails 46, 48, are situated between the headboard 44 and the first and the second side rails 50, 52, respectively. The user interface 42 is illustratively mounted on the first side rail 50.

The base 12 includes a base frame 54, a first head end strut 56, a second head end strut 58, a first foot end strut 60, and a second foot end strut (not shown). The first and the second head-end struts 56, 58, are coupled to the head-end of base frame 54 and to the deck 14 near the head end of the deck 14. The first head end strut 60 and the second foot-end strut are coupled to the foot-end of the base frame 54 and to the deck 14 such that the foot-end of the deck 14 is cantilevered over the base 12.

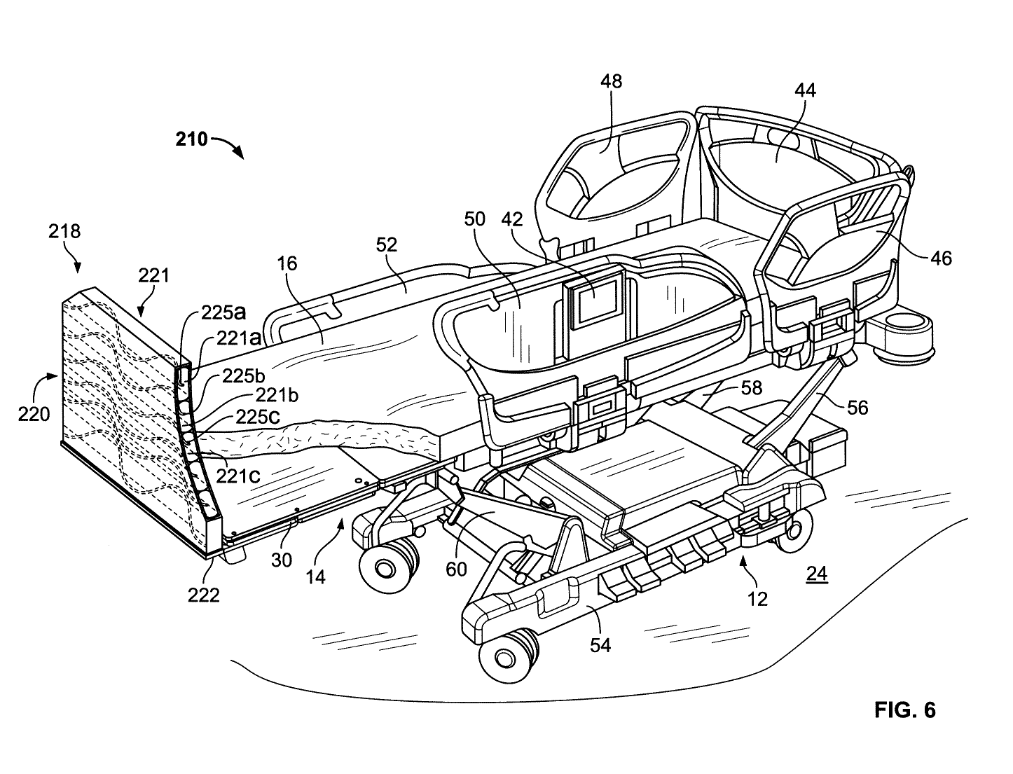

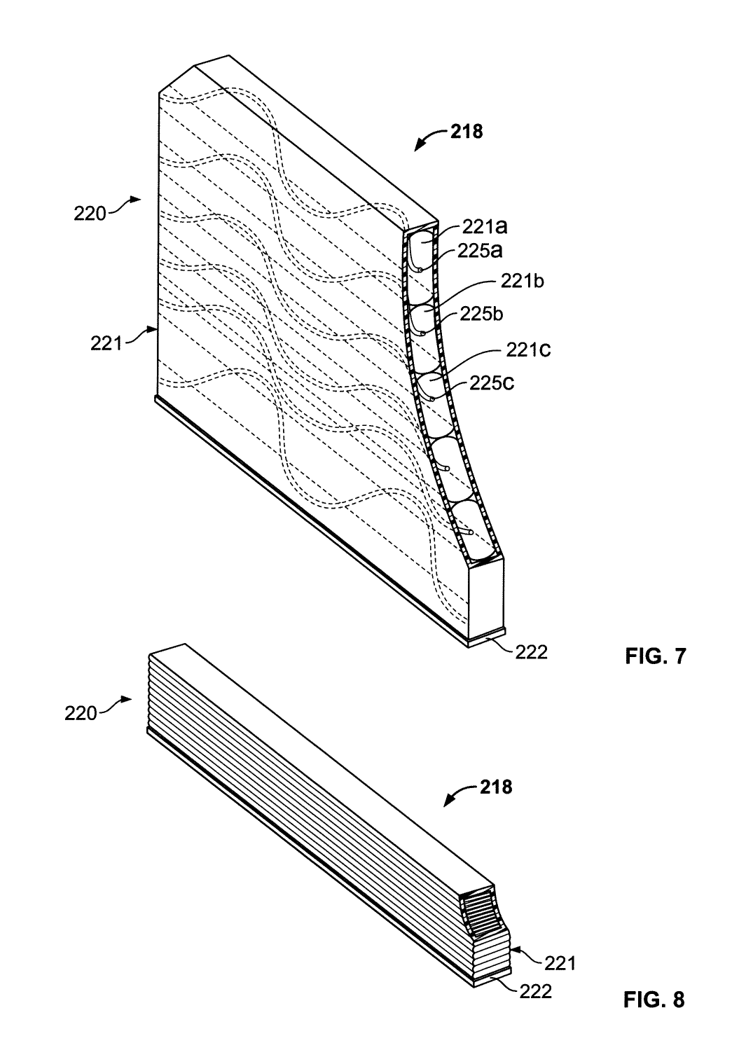

A bed 210 is shown in FIGS. 6-9 with another footboard embodiment (hereinafter referenced as a footboard 218). Some features of the embodiment illustrated in FIGS. 6-9 are similar to those discussed above in reference to the embodiment of FIGS. 1-5. Such features in FIGS. 6-9 are designated with the same reference numbers as those used in FIGS. 1-5.

The bed 210 includes a footboard 218 that is coupled to the foot end of the deck 14. The footboard 218 includes a footboard body 220 and a footboard deck member 222. The footboard body 220 includes, a plurality of inflatable bladders 221, and a footboard cover 223. The plurality of inflatable bladders 221 are situated within the footboard cover 223. The footboard body 220 is coupled to the foot end of the foot deck section 30. The footboard 218 is movable between a barrier position wherein the footboard is extended above a top surface of the mattress assembly 16 and a stowed position wherein the footboard 18 is retracted below the top surface of the mattress assembly 16.

The plurality of inflatable bladders 221 is inflatable to a range of volumes between a barrier volume corresponding to the barrier position of the footboard 18 and a stowed volume corresponding to the stowed position of the footboard 18. The plurality of inflatable bladders 221 includes a first bladder 221a, a second bladder 221b, and a third bladder 221c. The bladders 221a, 221b, 221c, extend along the foot end of the foot deck section 30. In some embodiments, more or fewer bladders may be used.

When the plurality of inflatable bladders 221 is inflated to the barrier volume, the top surfaces of the bladders 221a, 221b, 221c, are spaced apart from the top surfaces of the other bladders 221a, 221b, 221c. Conversely, when the plurality of inflatable bladders 221 inflated to the stowed volume the top surfaces of the bladders 221a, 221b, 221c, are positioned adjacent to the top surfaces of the other bladders 221a, 221b, 221c.

The footboard 218 further includes a footboard mover 232 and a footboard position sensor 234. The footboard mover 232 is configured to move the footboard 18 between the barrier position and the stowed position. The footboard position sensor 234 provides a signal indicative of the height of the top surface of the footboard 218 relative to the top surface of the foot deck section 30. In the illustrative embodiment, the footboard position sensor 234 is a string potentiometer.

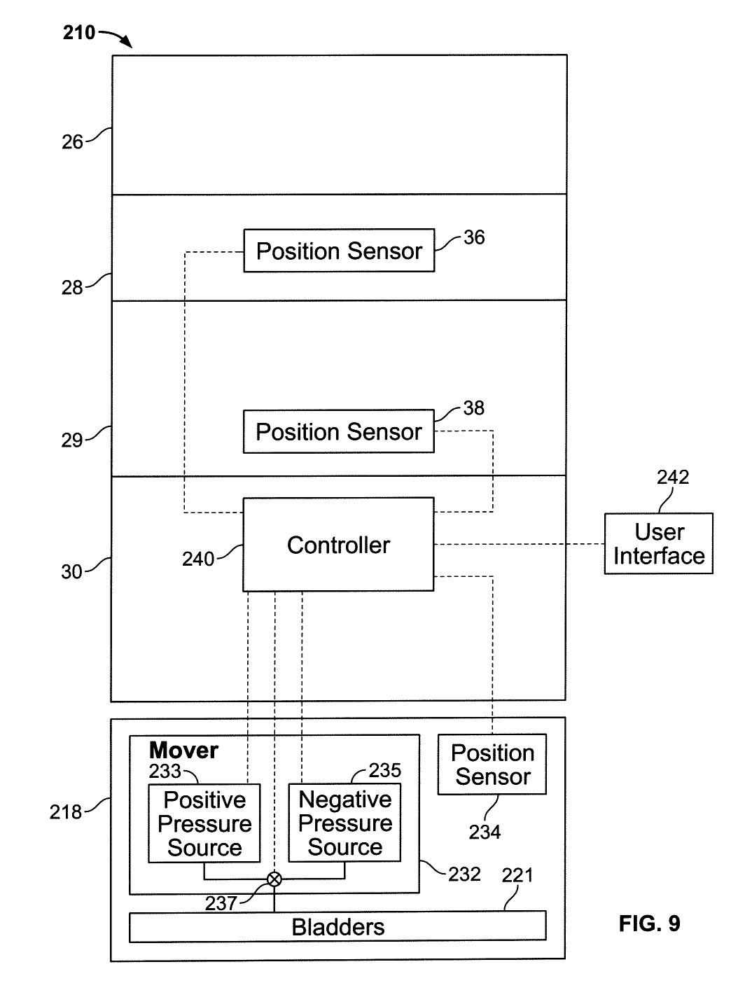

The footboard mover 232 includes a positive pressure source 233, a negative pressure source 235, and a valve 237 as shown in FIG. 9. The valve 237 is coupled between the positive pressure source 233 and the plurality of inflatable bladders 221. The valve 237 is also coupled between the negative pressure source 235 and the plurality of inflatable bladders 221.

The positive pressure source 233 is movable between an engaged position, wherein the positive pressure source 233 produces pressurized fluid, and a sealed position. In the illustrative embodiment, the pressurized fluid is air from the atmosphere. In other embodiments the fluid may be ferro-fluid from a ferro-fluid reservoir situated in the base 12.

The negative pressure source 235 is also movable between an engaged position wherein the negative pressure source 235 produces negative pressure and a sealed position. In the illustrative embodiment, the negative pressure source 235 expels air to the atmosphere. In other embodiments the negative pressure source is coupled to the ferro-fluid reservoir 236 situated in the base 12.

The valve 237 is movable between an open position and a closed position. In the open position, the valve 237 fluidly couples the positive pressure source 233 and the negative pressure source 235 with the plurality of inflatable bladders 221 to increase or decrease the volume of the plurality of inflatable bladders 221. In the closed position, the valve 237 seals the positive pressure source 233 and the negative pressure source 235 from the plurality of inflatable bladders 221 to maintain the pressure in the plurality of inflatable bladders 221. In some embodiments, the positive pressure source 233 and the negative pressure source 235 are combined into a reversible pressure source. In some embodiments, the negative pressure source is replaced by a vent.

The bed 210 further includes a controller 240 and a user interface 242. The controller 240 controls the positive pressure source movement between the engaged and sealed position, the negative pressure source 235 movement between the engaged and sealed position, and the valve 237 movement between the open and the closed position. The controller 240 signals the footboard mover 232 to drive the footboard 18 between the barrier position and the stowed position by operating the footboard mover 232 components 233, 235, 237. The controller 240 also signals the deck 14 to move between the horizontal bed position and the chair egress position.

The controller 240 is in communication with the user interface 242, the footboard position sensor 234, the head deck position sensor 36, and the foot deck position sensor 38. The user interface 242 receives inputs from a caregiver requesting movement of the deck 14 between the horizontal bed position and the chair egress position.

A caregiver requests movement of the deck 14 from the horizontal bed position to the chair egress position by selecting the chair egress position icon on the user interface 42. When a caregiver requests the chair egress position, the controller 240 moves the positive pressure source 233 to the sealed position, the negative pressure source 235 to the engaged position, and the valve 237 to the open position. The controller 240 then evaluates the height of the footboard 18 determined by the footboard position sensor 234 against a pre-set stowed height. Illustratively, the pre-set stowed height is less than four inches. When the controller 240 determines that the footboard has reached the pre-set stowed height, the controller 240 moves the negative pressure source 235 to the sealed position and moves the valve 237 to the closed position. Thus, the controller 240 signals the footboard mover 232 to drive the footboard 18 to the stowed position allowing a patient to exit the bed 210 onto the floor 24 without removing the footboard 18.

A caregiver requests movement of the deck 14 from the chair egress position to the horizontal bed position by selecting the horizontal bed icon on the user interface 42. When the caregiver requests the horizontal bed position, the controller 240 moves the positive pressure source 233 to the engaged position, the negative pressure source 235 to the sealed position, and the valve 237 to the open position. The controller 240 then evaluates the height of the footboard 18 determined by the footboard position sensor 234 against a pre-set barrier height. Illustratively, the pre-set barrier height is between 18 and 24 inches. When the controller 240 determines that the footboard has reached the pre-set barrier height, the controller 240 moves the positive pressure source 233 to the sealed position and moves the valve 237 to the closed position. In some embodiments where the pressurized fluid is a ferro-fluid, a current is applied to the ferro-fluid to stiffen the fluid while the footboard 218 is in the barrier position. Thus, the controller 240 signals the footboard mover 232 to drive the footboard 218 to the barrier position when the bed 210 is in the horizontal bed position.

Additionally, the user interface 242 receives inputs from a caregiver requesting an increased or a decreased height of the footboard 18 relative to the deck 14. When a caregiver requests an increased height, the controller 240 moves the positive pressure source 233 to the engaged position, the negative pressure source 235 to the sealed position, and the valve 237 to the open position. When a caregiver requests decreased height, the controller 240 moves the positive pressure source 233 to the sealed position, the negative pressure source 235 to the engaged position, and the valve 237 to the open position. When the desired height is indicated by the footboard position sensor 234, the controller 240 moves the positive pressure source 233 to the sealed position, the negative pressure source to the sealed position, and moves the valve 237 to the closed position. In embodiments where the pressurized fluid is a ferro-fluid, a current is applied to the ferro-fluid to stiffen the fluid in the footboard 218 when the desired height is indicated by the footboard position sensor 234. Thus, the footboard 18 is positionable at a range of heights between the barrier position and the stowed position.

Each of the bladders 221a, 221b, 221c, includes a corresponding internal baffle 225a, 225b, 225c, situated within each respective bladder 221a, 221b, 221c, and supporting each bladder 221a, 221b, 221c, when the bladders 221a, 221b, 221c, are inflated.

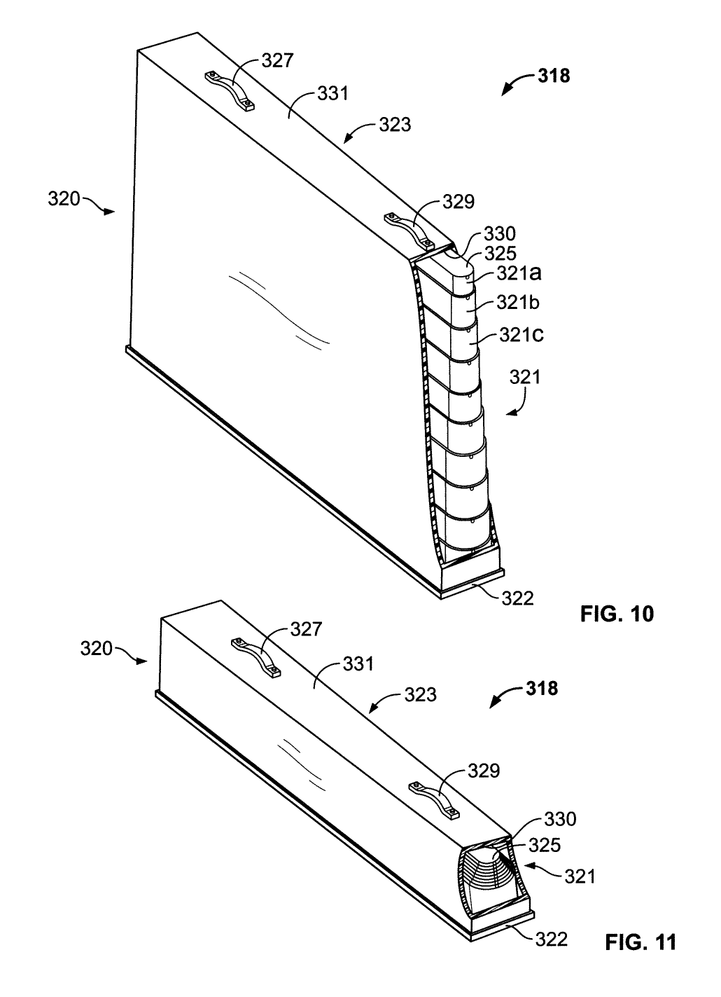

Another footboard embodiment 318 is shown in FIGS. 10-11 includes a footboard body 320 and a footboard deck member 322. The footboard body 320 is supported on the footboard deck member 322 and includes a plurality of telescoping members 321 and a footboard cover 323. The plurality of telescoping members 321 are situated within the footboard cover 323. The footboard body 320 is coupled to the foot end of the foot deck section 30. The footboard 318 is movable between a barrier position (as shown in FIG. 10), where the footboard 318 is extended, and a stowed position (as shown in FIG. 11), where the footboard 318 is retracted.

The plurality of telescoping members 321 is movable to a number of positions between a barrier position, corresponding to the barrier position of the footboard 318, and a stowed position, corresponding to the stowed position of the footboard 318. Each of the plurality of telescoping members 321 includes a first telescoping member 321a, a second telescoping member 321b, and a third telescoping member 321c. Each of the telescoping members 321a, 321b, 321c, extends along the foot end of the foot deck section 30. It should be understood that in some embodiments, more or fewer telescoping members may be used.

The bottom perimeter of the first telescoping member 321a is sized to be larger than the top perimeter of the second telescoping member 321b. The top perimeter of the first telescoping member 321a is sized to be smaller than the top perimeter of the second telescoping member 321b. The bottom perimeter of the second telescoping member 321b is sized to be larger than the top perimeter of the third telescoping member 321c. The top perimeter of the second telescoping member 321b is sized to be smaller than the top perimeter of the second telescoping member 321c.

When the plurality of telescoping members 321 is moved to the barrier configuration the top surfaces of the telescoping members 321a, 321b, 321c, are spaced apart from the top surface of the other telescoping members 321a, 321b, 321c. Also, while the plurality of telescoping members 321 is moved to the barrier configuration, the bottom of the first telescoping member 321a is frictionally locked with the bottom of the second telescoping member 321b and the bottom of the second telescoping member 321b is frictionally locked with the third telescoping member 321c. Conversely, when the plurality of telescoping members 321 moved to the stowed configuration, the top surfaces of the telescoping members 321a, 321b, 321c, are positioned adjacent to the top surfaces of the other telescoping members 321a, 321b, 321c.

A top surface 325 of telescoping member 321a is coupled to an inside surface 330 of the footboard cover 323. The footboard cover 323 includes a first handle 327 and a second handle 329 coupled to an outside surface 331 of the footboard cover 323. A caregiver pulls up on the first handle 327 and the second handle 329 to move plurality of telescoping members 321 moved to the barrier configuration. A caregiver pushes down on the first handle 327 and the second handle 329 to move plurality of telescoping members 321 moved to the stowed configuration.

In some embodiments, the footboard 318 is movable between the stowed and barrier positions by a pneumatic air system with a pneumatic mover and user interface similar to that shown in FIG. 9 and described in relation to footboard 218. In such embodiments, the plurality of telescoping members 321 is substantially pneumatically sealed at the interfaces between individual members. In some embodiments, a flexible membrane is coupled between telescoping members 321a, 321b, 321c. In still other embodiments, a bladder may be positioned within the plurality of telescoping members 321 and the bladder may be inflated and deflated to move the plurality of telescoping members between the barrier and stowed positions.

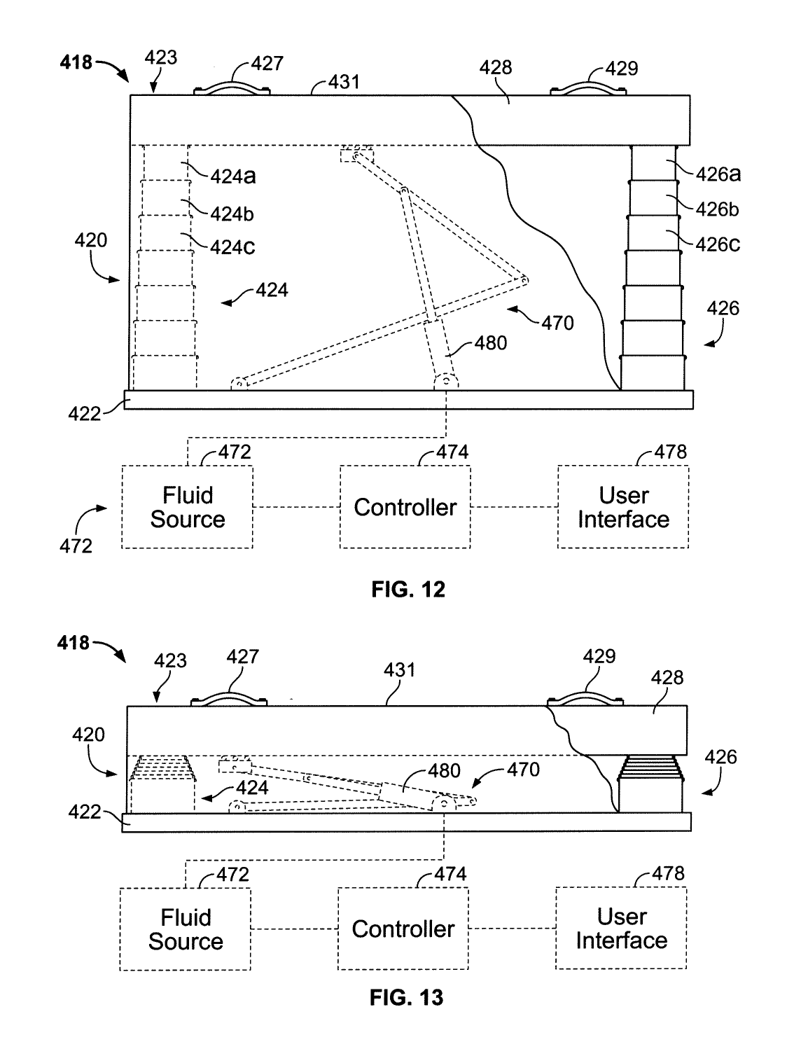

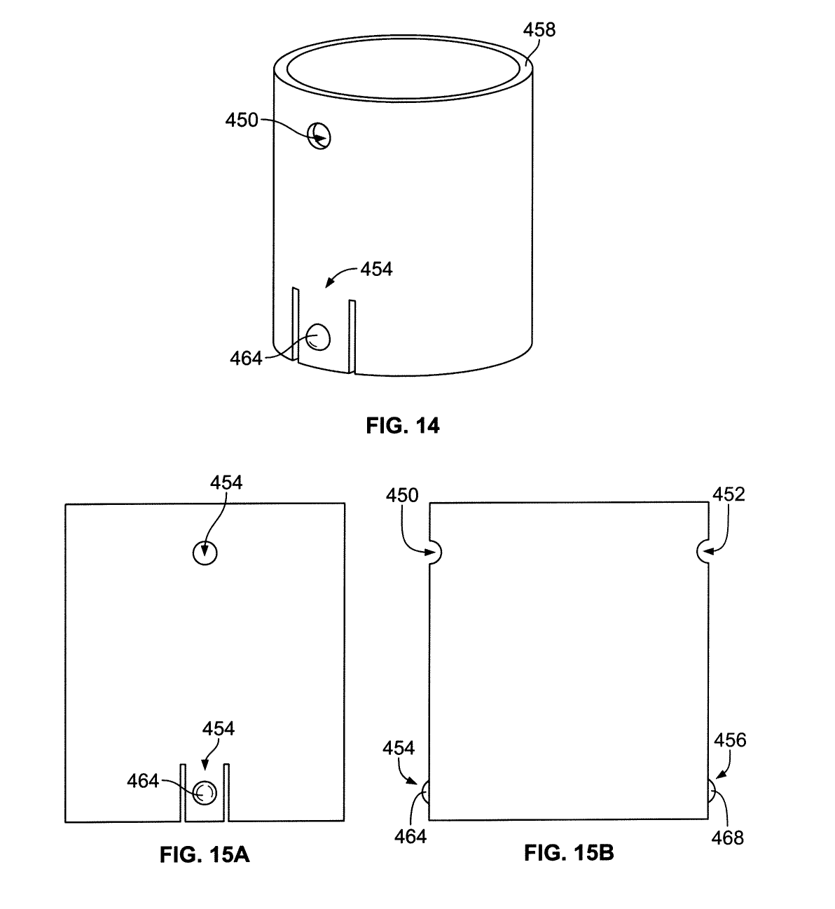

Another embodiment of a footboard 418 is shown in FIGS. 12-15 includes a footboard body 420 and a footboard deck member 422. The footboard body 420 is supported on the footboard deck member 422 and includes a first plurality of telescoping members 424, a second plurality of telescoping members 426, a crossbar 428, and a footboard cover 423. The crossbar 428 extends along the footboard deck member 222 and is coupled to the top surfaces of the first and the second plurality of telescoping members 424, 426. The first and the second plurality of telescoping members 424, 426, are spaced apart from one another and are coupled to the footboard deck member 222. The first plurality of telescoping members 424, the second plurality of telescoping members 426, and the crossbar 428 are situated within the footboard cover 423. The footboard 418 is movable between a barrier position (as shown in FIG. 12) wherein the footboard 418 is extended, and a stowed position (as shown in FIG. 13) wherein the footboard 418 is retracted.

The first and the second plurality of telescoping members 424, 426, are movable to series of positions between a barrier position, corresponding to the barrier position of the footboard 418, and a stowed position, corresponding to the stowed position of the footboard 418. The first plurality of telescoping members 424 includes a first telescoping member 424a, a second telescoping member 424b, and a third telescoping member 424c. The second plurality of telescoping members 426 includes a first telescoping member 426a, a second telescoping member 426b, and a third telescoping member 426c. It should be understood that in some embodiments, more or fewer telescoping members may be used.

The top surface of the crossbar 428 is coupled to an inside surface 325 of the footboard cover 423. The footboard cover 423 includes a first handle 427 and a second handle 429 coupled to an outside surface 431 of the footboard cover 423. A caregiver pulls up on the first handle 427 and the second handle 429 to move the first and the second plurality of telescoping members 424, 426, to the barrier configuration. A caregiver pushes down on the first handle 427 and the second handle 429 to move the first and the second plurality of telescoping members 424, 426, to the stowed configuration.

The telescoping members 424, 426, include a first detent hole 450 and a second detent hole 452 extending through the telescoping members 424, 426. The telescoping members 424, 426, further include a first detent tab 454 and a second detent tab 456. The first detent hole 450 is situated near a top surface 458 of the telescoping members 424, 426, and extends through a first side 460 of the telescoping members 424, 426. The second detent hole 452 is situated near the top surface 458 of the telescoping members 424, 426, and extends through a second side 462 of the telescoping members 424, 426.

The first detent tab 454 includes a dome protrusion 464 movable between a first position, extending beyond the first side 460 of the telescoping members 424, 426, and a second position, flush with the first side 460 of the telescoping members 424, 426. The second detent tab 456 includes a dome protrusion 468 movable between a first position, extending beyond the second side 462 of the telescoping members 424, 426, and a second position, flush with the second side 462 of the telescoping members 424, 426. The first detent tab 454 is situated below the first detent hole 450. The second detent tab 456 is situated below the second detent hole 452.

The first detent tab 454 of telescoping members 424, 426, engages the first detent hole 452 of another telescoping member 424, 426, when the footboard 418 is moved to a barrier position. Similarly, the second detent tab 456 of telescoping members 424, 426 engages the second detent hole 452 of another telescoping member 424, 426, when the footboard 418 is moved to a barrier position.

The first detent tab 454 of telescoping members 424, 426, disengages the first detent hole 452 of another telescoping member 424, 426, when a footboard 418 is moved to a stowed position. Similarly, the second detent tab 456 of telescoping members 424, 426, disengages the second detent hole 452 of another telescoping member 424, 426, when the footboard 418 is moved to a stowed position.

In some embodiments, the footboard 418 is movable between the stowed and barrier positions by a mechanical linkage system 470 (shown in ghost lines in FIGS. 12-13) including a fluid source 472, a controller 474, and a user interface 478. The fluid source 472, the controller 474, and the user interface 478 are operational as is well known in the art. In such embodiments, the mover 472 is a mechanical linkage including a pneumatic piston 480. The mechanical linkage system 470 is coupled to the footboard deck member 222 and slidably coupled to the crossbar 428.

Although certain illustrative embodiments have been described in detail above, variations and modifications exist within the scope and spirit of this disclosure as described and as defined in the following claims.

1. A patient support apparatus comprising
a deck having a head end and a foot end,
a mattress assembly supported on the deck, and
a footboard coupled to the deck, the footboard movable between a barrier position, wherein the footboard extends above a top surface of the mattress assembly, and a stowed position, wherein the footboard is below the top surface of the mattress assembly.

2. The patient support apparatus of claim 1, wherein the footboard is
pivotable about an approximately horizontal axis along the foot end of the deck over more than 180 degrees relative to the deck.

3. The patient support apparatus of claim 2, wherein the footboard is pivotable over about 270 degrees relative to the deck.

4. The patient support apparatus of claim 2, wherein the footboard is configured to hold position relative to the deck at any angle within the footboard range of motion relative to the deck.

5. The patient support apparatus of claim 2, wherein the footboard is pivotable between the barrier position, the stowed position, and a shelf position, wherein the footboard extends generally parallel to a floor.

6. The patient support apparatus of claim 2, wherein the deck is movable between a horizontal bed position, having a generally horizontal sleeping surface upon which a person lies in a supine position, and a chair egress position, allowing a person to exit the support from a sitting position.

7. The patient support apparatus of claim 6, wherein the deck is movable to the chair egress position when the footboard is moved to the stowed position.

8. The patient support apparatus of claim 6, wherein the footboard is movable to the barrier position when the deck moves away from the chair egress position.

9. A patient support apparatus comprising
a deck having a head end and a foot end, and
a footboard coupled to the foot end of the deck and the footboard expandable and retractable within a footboard footprint to increase and reduce the overall height of the footboard,
wherein the footboard footprint is defined by the length dimension of the footboard, extending from the foot end of the deck to the foot end of the footboard, and width dimension of the footboard, extending along at least a portion of the foot end of the deck.

10. The patient support apparatus of claim 9, wherein the footboard includes a series of chambers expandable and retractable between a first position, wherein the top surface of each chamber is spaced apart from the top surface of each other chamber, and a second position, wherein the top surface of at least one chamber is adjacent to the top surface of another chamber.

11. The patient support apparatus of claim 10, wherein the deck is movable between a horizontal bed position, having a generally horizontal sleeping surface upon which a person lies in a supine position, and a chair egress position, allowing a person to exit the support from a sitting position.

12. The patient support apparatus of claim 11, wherein the footboard is retracted to the second position when the deck is moved to the chair egress position.

13. The patient support apparatus of claim 10, wherein the footboard includes a plurality of inflatable bladders.

14. The patient support apparatus of claim 13, wherein the plurality of inflatable bladders extend approximately horizontally along the foot end of the deck.

15. The patient support apparatus of claim 10, wherein the footboard includes a plurality of telescoping members.

16. The patient support apparatus of claim 15, wherein each of the plurality of telescoping members overlaps a portion of another telescoping member creating a friction fit when the footboard is in the first position.

17. The patient support apparatus of claim 9, further comprising a mattress assembly supported on the deck wherein the footboard is movable between a barrier position, wherein the footboard extends above a top surface of the mattress assembly, and a stowed position, wherein the footboard is below the top surface of the mattress assembly.

18. The patient support apparatus of claim 17, wherein the deck is movable between a horizontal bed position, having a generally horizontal sleeping surface upon which a person lies in a supine position, and a chair egress position, allowing a person to exit the support from a sitting position.

19. The patient support of claim 18, wherein the footboard is moved to the stowed position when the deck is in the chair egress position.

20. The patient support apparatus of claim 9, wherein the footboard expands and retracts between, and is be maintained at, a plurality of heights.
